(19) United States
(12) Patent Application Publication
(10) Pub. No.: US 2015/0176802 A1
(43) Pub. Date: Jun. 25, 2015

(54) Radiation arrangement for providing electromagnetic radiation

(71) Applicant: OSRAM GmbH, Munich (DE)

(72) Inventors: Stephan Malkmus, Puchheim (DE); Julius Muschaweck, Gauting (DE); Tobias Schmidt, Augsburg (DE)

(21) Appl. No.: 14/416,699

(22) PCT Filed: Jul. 19, 2013
(86) PCT No.: PCT/EP2013/065295

§ 371 Date: Jan. 23, 2015

(30) Foreign Application Priority Data
Jul. 26, 2012 (DE) 102012213194.9

(51) Int. Cl. F21V 7/00; F21K 99/00

(52) U.S. Cl. CPC F21V 7/0091; F21K 9/58; F21Y 2101/02

(57) ABSTRACT

Various embodiments may relate to a radiation arrangement for providing electromagnetic radiation, including at least one radiation source for generating and outputting electromagnetic radiation, and an optical body, which has an outer wall and an inner wall, wherein the inner wall faces the radiation source and has a reflector, wherein the optical body is configured and arranged with respect to the radiation source such that the reflector reflects at least a portion of the electromagnetic radiation back to the radiation source, and that at least a portion of the electromagnetic radiation enters the optical body through the inner wall, and that the outer wall internally reflects at least a portion of the electromagnetic radiation which has entered the optical body, and that at least part of the internally reflected electromagnetic radiation exits the optical body.

### RELATED APPLICATIONS

The present application is a national stage entry according to 35 U.S.C. §371 of PCT application No.: PCT/EP2013/065295 filed on Jul. 19, 2013, which claims priority from German application No.: 10 2012 213 194.9 filed on Jul. 26, 2012, and is incorporated herein by reference in its entirety.

### TECHNICAL FIELD

Various embodiments relate to a radiation arrangement for providing electromagnetic radiation, having at least one radiation source for generating electromagnetic radiation and having an optical body. The optical body has an outer wall and an inner wall. The inner wall faces the radiation source. The optical body is configured and arranged with respect to the radiation source such that at least a portion of the electromagnetic radiation enters the optical body through the inner wall and that the outer wall internally reflects at least a portion of the electromagnetic radiation which has entered the optical body.

### BACKGROUND

Known are modern radiation sources which have, for example, one, two or more LEDs or OLEDs and/or light engines, in which a color distribution and/or brightness distribution of the electromagnetic radiation generated thereby is inhomogeneous. For example, some LEDs have active and non-active regions. When the LED with its active and non-active regions is optically imaged for example on a screen, for example using an optical unit, the active and non-active regions can be imaged such that a projection of the electromagnetic radiation, for example light, has bright and not so bright regions. For example, a light spot of a light source with active and non-active regions can have regions of varying brightness. Such imaging in the far field can occur for example in the case of headlights in a motor vehicle, when illuminating landing and take-off runways at airports, in the case of flashlights, lighthouses, emitters, for example in LED retrofits for halogen emitters, and/or in signal lamps. By way of example, it is in particular especially efficient and narrowly focused headlight applications, for example etendue-limited systems and/or collimating optical units, that image locally inhomogeneous emissions of the radiation source in the far field. Such radiation sources are, for example, assembled LED modules, RGB-LEDs, mid-power LED arrays, volume casting LEDs and flip-chip LEDs.

Alternatively or additionally to the inhomogeneous brightness distribution, it is also possible for an inhomogeneous color distribution of the radiation source to be imaged in the far field, for example in the case of an RGB-LED module. In such an RGB-LED module, a plurality of active regions which emit in each case light of a different color are arranged next to one another on a module. If said emitted light is imaged using a collimating optical unit, different spatial regions are illuminated with light of different colors. For example, a light spot of a light source having active regions of different colors can have regions of different colors.

In radiation sources, the maximum achievable radiant intensity is furthermore frequently a decisive feature. By way of example, the maximum achievable radiant intensity is one of the most important features especially in headlight applications. The maximum achievable radiant intensity of a radiation source, for example a headlight application, is determined, with given dimensions of the optical unit, by the luminance of the radiation source used. In a structured radiation source for example having active and non-active regions, the average luminance is decisive.

In order to generate homogeneous radiation, for example for homogenizing the color distribution and/or the brightness distribution, it is known to use Köhler illumination and/or to subject the generated radiation to one or more scattering processes. Köhler illumination can, for example, be disadvantageous with respect to the efficiency and requires additional optical elements which in principle require installation space. When the emitted radiation is scattered, additional optical elements, such as for example micro-lenses or prismatic structures, are likewise required. Here, the light distribution can widen and the maximum radiant intensity can decrease. In addition, the efficiency of the lamp with the scattering optical unit can be low.

In order to increase the average luminance in LEDs, it is known for example to package the individual LEDs and/or the active regions thereof closer together. However, closer packaging of the LEDs or of the active regions of the LEDs in principle leads to increased heat generation when operating the radiation source and to increased complexity in a manufacturing process for producing the radiation source.

### SUMMARY

In various embodiments, a radiation arrangement is provided which allows, in a simple and/or efficient manner, for homogeneous electromagnetic radiation to be generated, wherein the electromagnetic radiation is homogeneous for example with respect to the radiance and/or the color distribution of the generated electromagnetic radiation. Alternatively or additionally, the radiation arrangement can contribute to electromagnetic radiation having a high radiant intensity being generated.

In various embodiments, a radiation arrangement having at least one radiation source for generating and outputting electromagnetic radiation and having an optical body is provided. The optical body has an outer wall and an inner wall. The inner wall faces the radiation source and has a reflector.

The optical body is configured and arranged with respect to the radiation source such that the reflector reflects at least a portion of the electromagnetic radiation back to the radiation source, and that at least a portion of the electromagnetic radiation enters the optical body through the inner wall, and that the outer wall internally reflects at least a portion of the electromagnetic radiation which has entered the optical body. At least part of the internally reflected electromagnetic radiation exits the optical body.

The radiation source can be, for example, configured to be diffusely scattering and/or reflective, for example highly reflective. Here, the reflection is a special case of scattering, in which an angle of incidence of the electromagnetic radiation is equal to an angle of reflection of the electromagnetic radiation. The radiation source can be configured to be reflective or at least partially reflective. For example, the radiation source may be a Lambert emitter. For example, the radiation source can have, on its surface, white material and/or material having a high reflectance, for example TiO₂ in silicone. The generated electromagnetic radiation can, for example, be light in the visible range, UV light and/or infrared light, wherein the radiation source in that case can also be referred to as a light source, the radiation arrangement may also be referred to as an illumination arrangement, and/or the electromagnetic radiation provided by the radiation arrangement may also be referred to as illumination light and/or usable light. For example, the internally reflected electromagnetic radiation exiting the optical body may be referred to as provided electromagnetic radiation. The reflector is configured for example in the form of a concave mirror. This allows in a particularly simple manner the reflection of the electromagnetic radiation, which is emitted and/or output by the radiation source in the direction toward the reflector, back to the radiation source. The fact that the first reflector is configured in the form of a concave mirror means, for example, that the first reflector is curved inwardly. The radiation arrangement outputs the electromagnetic radiation that is internally reflected on the outer wall toward the outside, for example in the form of usable electromagnetic radiation.

The radiation source generates the electromagnetic radiation, in particular the two portions of the electromagnetic radiation. The reflector reflects one of the two portions of the electromagnetic radiation generated by the radiation source back to the radiation source. The electromagnetic radiation reflected by the reflector is reflected by the radiation source, for example via Fresnel reflection, for example at its surface facing the reflector. Outputting the electromagnetic radiation by the radiation source includes for example said reflection of the electromagnetic radiation at the radiation source. Alternatively or additionally, the electromagnetic radiation reflected by the reflector to the radiation source is scattered by the radiation source, for example inside the radiation source, at a surface of the radiation source facing the reflector and/or on a bottom side of the radiation source that is remote from the reflector, for example internally on the outer wall of the radiation source or externally on a carrier on which the radiation source is arranged. Outputting the electromagnetic radiation by the radiation source includes, for example, said scattering of the electromagnetic radiation on and/or at the radiation source. Alternatively or additionally, the electromagnetic radiation in the radiation source reflected by the reflector to the radiation source effects, by excitation, the generation of additional electromagnetic radiation, which may be referred to, for example, as recycling. Outputting the electromagnetic radiation by the radiation source includes, for example, said recycling of the electromagnetic radiation.

Outputting the electromagnetic radiation results in a mixing of the output and generated electromagnetic radiation. This effects homogenization of a luminance distribution and, if appropriate, a color distribution of the electromagnetic radiation provided using the radiation arrangement. If the mixed electromagnetic radiation is output by the radiation source back in the direction of the first reflector, the process of light mixing can repeat itself, as a result of which the electromagnetic radiation becomes increasingly homogenized.

The outer wall reflects the portion of the electromagnetic radiation that is incident thereon owing to internal reflection, for example owing to total internal reflection. The optical body can, for example, contribute to the radiation arrangement being configured in a simple and/or compact manner. The radiation source is arranged in relation to the optical body such that one portion of the electromagnetic radiation may be incident on the reflector while the other portion of the electromagnetic radiation can be coupled into the optical body via the inner walls of the cutout. The optical body can, for example, consist of a single piece or of multiple pieces.

The radiation arrangement allows in a particularly simple and efficient manner the provision of electromagnetic radiation with a homogeneous luminance distribution, radiant intensity distribution, illuminance and/or color distribution.

In various embodiments, the portion of the electromagnetic radiation that is incident on the reflector includes a first radiation portion, which the radiation source generates and emits in the direction of the first reflector. In addition, the portion of the electromagnetic radiation that is incident on the reflector includes a second radiation portion, which the radiation source outputs in the direction of the reflector owing to electromagnetic radiation that is incident on the radiation source after reflection at the reflector.

In various embodiments, the portion of the electromagnetic radiation that enters the optical body through the inner wall includes a third radiation portion, which the radiation source generates and emits in the direction of the outer wall. In addition, the portion of the electromagnetic radiation that enters the optical body through the inner wall includes a fourth radiation portion, which the radiation source outputs in the direction of the outer wall owing to electromagnetic radiation that is incident on the radiation source after reflection at the reflector.

In various embodiments, the electromagnetic radiation that the radiation source outputs includes electromagnetic radiation that the radiation source reflects, scatters and/or generates owing to excitation by electromagnetic radiation that is reflected back onto the radiation source.

In various embodiments, the radiation source includes an active region, at which the radiation source generates and/or outputs the electromagnetic radiation, and a passive region, at which the radiation source outputs the electromagnetic radiation, for example reflects and/or scatters it. The active and/or the passive region can be, for example, configured to be diffusely scattering and/or reflective, for example highly reflective. The reflection in this case represents a special case of scattering, in which an angle of incidence of the electromagnetic radiation is equal to an angle of reflection of the electromagnetic radiation. The active and/or the passive region can be configured to be reflective or at least partially reflective. By way of example, the active region may be a Lambert emitter. By way of example, the active and/or the passive region can have, on their surfaces, white material and/or material having a high reflectance, for example TiO₂ in silicone.

The active and the passive region effect in principle inhomogeneous luminance distribution of the electromagnetic radiation generated by the radiation source, which, without the reflector, would result in inhomogeneous brightness distribution of the electromagnetic radiation provided by the radiation arrangement. If two or more active regions are formed, which in each case emit electromagnetic radiation of different colors, then, without the optical body with the reflector, the various active regions would lead to inhomogeneous color distribution of the electromagnetic radiation provided by the radiation arrangement. However, the optical body with the reflector and the mixing of the electromagnetic radiation generated by the active region with the electromagnetic radiation output by the active and the passive regions achieved thereby effects homogeneous luminance distribution and/or homogeneous color distribution of the electromagnetic radiation output by the radiation arrangement. Thus, both the active region and the passive region may contribute to the output of the electromagnetic radiation and to the provision of the portion of the electromagnetic radiation which is output by the radiation source in the direction toward the outer wall and which subsequently forms part of the electromagnetic radiation provided by the radiation arrangement.

In various embodiments, the optical body has a cutout which extends into the optical body in a direction of extent. The cutout is delimited in its direction of extent by a base area of the cutout and is delimited vertically to its direction of extent by the inner wall of the optical body. The reflector is formed on the base area. The cutout does not extend completely through the optical body, but terminates at the base area. The inner wall of the optical body connects part of the outer surface of the optical body to the base area. By way of example, the radiation source is arranged at least partially in the cutout of the optical body. By way of example, at least the first side of the radiation source is arranged inside the cutout of the optical body.

In various embodiments, the active and/or the passive region have an outer edge. The reflector is configured such that it reflects the first radiation portion and the second radiation portion onto the outer edge. As a result, electromagnetic radiation which is emitted and/or output by the outer edge of the radiation source in the direction of the reflector is reflected back to the outer edge of the radiation source. In other words, the electromagnetic radiation which is collected by the reflector is reflected completely back to the radiation source. Rays of the electromagnetic radiation coming from the outer edge of the radiation source can also be referred to as edge rays. The edge rays can be directed back to the outer edge of the radiation source. This can contribute to a particularly high efficiency of the radiation arrangement.

In various embodiments, the outer edge has a first edge section and at least one second edge section. The reflector is configured such that it reflects the first and/or second radiation portions coming from the first edge section onto the second edge section. This may contribute to a particularly high efficiency of the radiation arrangement. The reflector can furthermore be configured such that it reflects the electromagnetic radiation coming from the second edge section to the first edge section.

In various embodiments, the reflector has a reflector cutout which extends through the reflector and via which portions of the first and/or second radiation portion can pass through the reflector. The reflector cutout can extend, for example, over a relatively small region of the first reflector. In this case, the reflector cutout can be configured such that, for example, on the one hand as much electromagnetic radiation as possible can pass through it, and on the other hand, however, the areally inhomogeneous structures of the radiation source are not imaged in the far field. By way of example, the reflector cutout can be configured such that it can be considered to be a punctiform or nearly punctiform radiation source. The reflector cutout can contribute to a particularly high radiant intensity of the electromagnetic radiation provided by the radiation arrangement, for example if the reflector cutout is arranged opposite a region of the radiation source which emits electromagnetic radiation having a high radiance. The maximum radiant intensity of the electromagnetic radiation provided using the radiation arrangement increases as the radiance increases and the cross-section of the reflector cutout increases.

In various embodiments, the optical body has a lens. The lens is arranged in a beam path of the electromagnetic radiation passing through the reflector cutout, downstream of the reflector. The lens can serve, for example, for collimating the electromagnetic radiation passing through the reflector cutout. By way of example, the lens can be configured such that the reflector cutout is imaged in the far field.

In various embodiments, the radiation source has, on the first side, at least one second active region for emitting the electromagnetic radiation. In addition, the radiation source can also have one, two or more further active regions. By way of example, the radiation source may have an LED arrangement which has LEDs in its active regions. Alternatively, the radiation source may have one or more LEDs having in each case a plurality of active regions. In the active regions, by way of example, electromagnetic radiation of identical wavelength or electromagnetic radiation of different wavelengths can be generated. For example, in a first active region, red light can be generated, in a second active region, green light can be generated, and in a third active region, blue light can be generated. The radiation source may be referred to, for example, as an RGB-LED module.

In various embodiments, the passive region is formed at least partially between the first active region and the second active region. This contributes to even the passive region between the active regions being able to contribute to the output of electromagnetic radiation, for example owing to scattering and/or reflection processes. This may contribute to a particularly efficient provision of homogeneous electromagnetic radiation, for example having a particularly high radiance and/or a particularly high radiant intensity.

In various embodiments, the reflector is arranged on the base area. By way of example, the reflector is formed by an independent body which is attached on the base area.

In various embodiments, the reflector is formed by the base area. By way of example, the base area itself may be of reflective design and/or be coated with a reflective layer.

In various embodiments, the optical body is a TIR optical unit (TIR=total internal reflection).

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the disclosed embodiments. In the following description, various embodiments described with reference to the following drawings, in which:

FIG. 1 shows an embodiment of a radiation arrangement,

FIG. 2 shows an embodiment of a radiation arrangement,

FIG. 3 shows a detail view of an embodiment of a radiation arrangement,

FIG. 4 shows a plan view of an embodiment of a radiation source,

FIG. 5 shows a plan view of an embodiment of a radiation source,

FIG. 6 shows a plan view of an embodiment of a radiation source,

FIG. 7 shows a plan view of an embodiment of a radiation source.

### DETAILED DESCRIPTION

In the following detailed description, reference is made to the accompanying drawings, which form part of this description and which show, for illustration purposes, specific embodiments in which the disclosure can be implemented. In this regard, direction terminology such as, for instance, “at the top”, “at the bottom”, “at the front”, “at the back”, “front”, “rear”, etc. is used with respect to the orientation of the figure(s) described. Since components of embodiments can be positioned in a number of different orientations, the direction terminology serves for illustration purposes and is not restrictive in any way whatsoever. It goes without saying that other embodiments can be used and structural or logical changes can be made, without departing from the scope of protection of the present disclosure. It goes without saying that the features of the various embodiments described herein can be combined with one another, unless specifically indicated otherwise. The following detailed description should therefore not be interpreted in a restrictive sense, and the scope of protection of the present disclosure is defined by the appended claims.

In the context of this description, the terms “connected” and “coupled” are used to describe both a direct and an indirect connection, and a direct or indirect coupling. In the figures, identical or similar elements are provided with identical reference signs, insofar as this is expedient.

In various embodiments, a device emitting electromagnetic radiation may be a semiconductor device emitting electromagnetic radiation and/or may be configured in the form of a light-emitting diode (LED), in the form of an organic light-emitting diode (OLED), or in the form of an organic transistor emitting light. In various embodiments, the device emitting electromagnetic radiation may be part of an integrated circuit and/or a light engine. Furthermore, a multiplicity of devices emitting electromagnetic radiation may be provided, for example accommodated in a common housing. The electromagnetic radiation may for example be light in the visible range, UV light and/or infrared light.

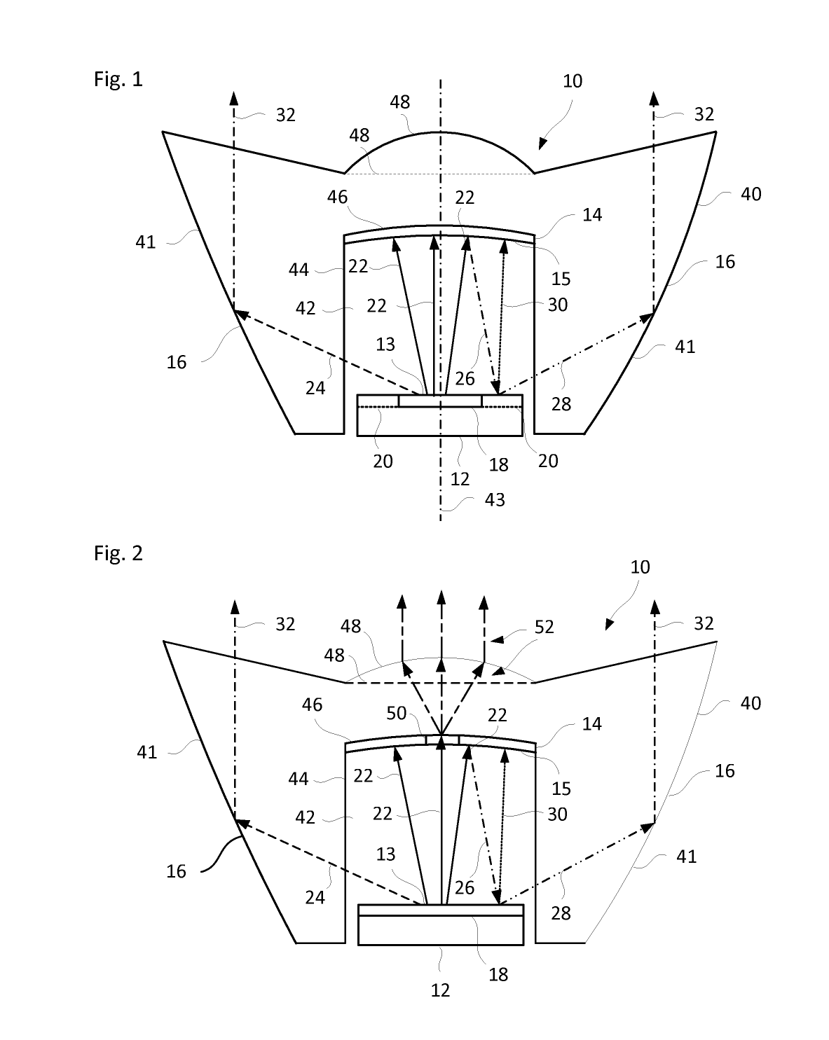

FIG. 1 shows a radiation arrangement 10. The radiation arrangement 10 is suitable, for example, for efficiently providing electromagnetic radiation 32, for example in headlights, for example for providing low beam light or high beam light in a motor vehicle and for illuminating take-off and/or landing runways at airports, in etendue-limited systems, in flashlights, in lighthouses, in emitters, for example in LED retrofits for halogen emitters, and/or in signal lamps.

The radiation arrangement 10 has a radiation source 12, a reflector 14 and an optical body (40). The radiation source 12 can be configured, for example, in the form of a device emitting electromagnetic radiation, or have one, two or more devices emitting electromagnetic radiation. The radiation source 12 has a first side 13. Formed on the first side 13 is at least one active region 18 for generating the electromagnetic radiation. If desired, at least one passive region 20 can additionally be formed on the first side 13. The active region 18 can be configured, for example, in the form of a device emitting electromagnetic radiation. By way of example, the radiation source 12 can include an assembled LED module, an RGB-LED, a Mid-power LED array, a flip-chip LED or an RGGB-LED.

The reflector 14 can include a reflective material, be made thereof or be coated therewith. By way of example, one surface of the reflector 14, for example a reflective surface 15, which is arranged opposite the first side 13 of the radiation source 12, can be configured to be reflective and/or be coated with a reflective layer. Alternatively, the reflector 14 may also have a transparent main body, for example made of glass, and its side that is remote from the radiation source 12 can be configured to be reflective. The transparent main body may in that case serve as protection for the reflective layer, for example. The reflector 14 may be configured, for example, in the form of a concave mirror. The reflective surface 15 of the reflector 14 can include, for example, a metal or a reflective plastic, for example a reflective polymer. By way of example, the reflective surface 15 can include aluminum and/or silver. The reflector 14 can be made entirely of the reflective material, or the reflective surface 15 can be applied as a reflective layer on the reflector 14. By way of example, the reflector 14 can be coated with the reflective layer.

The active and/or the passive region 18, 20 may be configured to be scattering, for example, which means that, for example, they have, for example, a white surface and/or a Lambert emission characteristic and/or are highly scattering and/or highly reflective. By way of example, 20% to 99.9%, for example 70% to 99.5%, for example 95% to 99% of the electromagnetic radiation that is incident on the active or passive region 18, 20 can be scattered or reflected. By way of example, the active and/or the passive region 20 can include TiO₂, which can be embedded, for example, in silicone. The active region 18 can furthermore be configured in the form of a Lambert emitter.

The optical body 40 has an outer wall 41, which extends, for example, around the entire periphery of the optical body 40. The optical body 40 has, for example, a cutout 42, which is formed, for example, centrally in the optical body 40. The cutout 42 extends in a direction of extent into the optical body 40 up to a base area 46 of the cutout 42. Perpendicularly to the direction of extent, the cutout 42 is delimited by an inner wall 44 of the optical body 40. Starting from the cutout 42, first the inner wall 44 of the optical body 40 is arranged perpendicular to the direction of extent of the cutout 42, and therebehind the outer wall 41. In FIG. 1, the inner wall 44 thus forms a lateral boundary of the cutout 42, and the base area 46 forms an upper delimitation of the cutout 42. The optical body 40 can be configured, for example, to be rotationally symmetrical with respect to an axis of symmetry 43. Alternatively, the optical body 40 can extend, for example, longitudinally into the drawing plane, and/or the optical body 40 can be extruded, for example.

The radiation source 12 can be arranged, for example, partially or entirely in the cutout 42. By way of example, at least the first side 13 of the radiation source 12 can be arranged in the cutout 42. The reflector 14 is arranged, for example, on the base area 46, formed thereon and/or formed thereby. The outer wall 41 can serve as a further reflector 16.

As viewed from the radiation source 12, the optical body 40 has, after the base area 46, an outer surface region 48. The outer surface region 48 can be configured, for example, in the form of a lens. Alternatively, the outer surface region can also have a flat configuration, which is indicated in FIG. 1 by way of a dashed line.

The optical body 40 can be configured to be, for example, made of one piece or of multiple pieces. By way of example, the optical body 40 can be produced in an injection molding method. The reflector 14 can be applied, for example, after manufacture of the optical body 40, onto the base area 46, for example can be adhesively bonded thereto, or the reflector 14 can be formed on the base area 46 as early as the production of the optical body 40. By way of example, the reflector 14 can be placed as an insert into a mold tool for molding the optical body 40. The optical body 40 may include or consist of, for example, glass or transparent base material, for example PMMA or PC.

The radiation source 12 generates electromagnetic radiation and outputs electromagnetic radiation. By way of example, the active region 18 generates a first radiation portion 22 of the electromagnetic radiation and emits said portion in the direction toward the reflector 14. The reflector 14 is configured and arranged such that at least part of the first radiation portion 22 is reflected back in the direction toward the radiation source 12 in the form of reflected electromagnetic radiation 26. At least part of the reflected electromagnetic radiation 26, for example all of the reflected electromagnetic radiation 26, is incident on the radiation source 12, for example on the active region 18 and/or the passive region 20.

The reflected electromagnetic radiation 26 that is incident on the radiation source 12 is output at least partially by the radiation source 12, for example by the passive region 20 and/or the active region 18. Outputting the electromagnetic radiation includes, for example, reflecting or scattering the electromagnetic radiation, for example at the first side 13 of the radiation source 12, in the radiation source 12, for example in the active and/or passive region 18, 20, and/or on or at a second side of the radiation source 12 and/or the active and/or passive region 18, 20 which is remote from the first side 13. Furthermore, outputting the electromagnetic radiation with respect to the active region 18 may also include generating additional electromagnetic radiation which is brought about by excitation by the reflected electromagnetic radiation 26. The generation of the additional electromagnetic radiation can also be referred to as recycling.

A second radiation portion 30 is output by the radiation source 12, for example by the active and/or the passive region 18, 20 in the direction toward the reflector 14. At least part of the second radiation portion 30 is reflected back to the radiation source 12 by the reflector 14 in the form of reflected electromagnetic radiation 26.

A third radiation portion 24 is generated by the radiation source 12, for example by the active region 18, and is emitted in the direction toward the inner wall 44 of the cutout 42 of the optical body 40, specifically not in the direction toward the reflector 14. A fourth radiation portion 28 is output by the radiation source 12, for example by the active and/or by the passive region 18, 20, specifically in the direction toward the inner wall 44 of the cutout 42 of the optical body 40 rather than the direction toward the reflector 14. The third and/or the fourth radiation portion 24, 28 are transmitted through the optical body 40 up to the outer wall 41 of the optical body. By way of example, the fourth radiation portion 28 can be scattered or reflected in the direction toward the outer wall 41.

The outer wall is configured such that the radiation portions 24, 28 that are incident thereon are internally reflected at the outer wall 41. By way of example, the outer wall 41 can be configured such that the third and the fourth radiation portions 24, 28 undergo total internal reflection at the outer wall 41. The outer wall 41 reflects the third radiation portion 24 and/or the fourth radiation portion 28 in the form of usable electromagnetic radiation 32 provided by the radiation arrangement 10 in the direction away from the radiation source 12.

The first radiation portion 22 is illustrated in the figures by way of solid arrows. The second radiation portion 30 is illustrated in the figures by way of dotted arrows. The third radiation portion 24 is illustrated in the figures by way of dashed arrows. The fourth radiation portion 28 is illustrated in the figures by way of dash-double-dot arrows. The reflected radiation portion 26 is illustrated in the figures by way of dash-dot arrows. The electromagnetic radiation 32 provided by the radiation arrangement 10 is illustrated in the figures by way of double-dash-dot arrows. The arrows which represent the various radiation portions are representative for all beam paths of the electromagnetic radiation of the corresponding radiation portion. By way of example, the radiation portions have in each case beams of rays, wherein each of the beams is represented by one of the arrows. Inside one of the beams, however, beam paths of the electromagnetic radiation can have directions which deviate from the direction of the corresponding arrow. In that case, the entire electromagnetic radiation, the beam paths of which have properties which are described with respect to the corresponding radiation portion, belongs to a beam of electromagnetic radiation and the corresponding arrow.

The first and third radiation portions 22, 24 that are generated by the active region 18 can, for example, include electromagnetic radiation having wavelengths in the visible range. By way of example, the radiation portions 22, 24 that are emitted by the radiation source 12 can include red, green, blue and/or white light. Alternatively, the emitted electromagnetic radiation can include UV light or infrared light and/or laser light.

FIG. 2 shows an embodiment of the radiation arrangement 10, which largely corresponds to the embodiment of the radiation arrangement 10 shown in FIG. 1. In contrast therewith, however, the embodiment of the radiation arrangement 10 shown in FIG. 2 has a reflector cutout 50, which extends through the first reflector 14. In contrast to FIG. 1, the radiation source 12 additionally has no passive region 20 on the first side 13. Alternatively, however, the radiation source 12 can have both the active and the passive region 18, 20 in the embodiment shown in FIG. 2. Furthermore, it is also possible that the radiation source 12 in the embodiment shown in FIG. 1 has no passive region 18.

The reflector cutout 50 effects that part of the first and/or second radiation portion 22, 30 can enter the optical body 40 through the reflector 14. The reflector cutout 50 in that case serves as the radiation source for transmitted electromagnetic radiation 52, which is illustrated in FIG. 2 by way of arrows having long and short dashes and which is usable as electromagnetic radiation 32 provided by the radiation arrangement 10. If the outer surface region 48 is configured in the form of a lens, the outer surface region 48 can contribute to the collimation of the transmitted electromagnetic radiation 52. Alternatively or additionally, the outer surface region 48 can be configured such that it images the reflector cutout 50 in the far field.

The reflector cutout 50 and/or the lens-type outer surface region 48 can simply contribute to the achievability of a particularly high maximum achievable radiant intensity using the radiation arrangement 10. The reflector cutout 50 extends, for example, in the radial direction only over a small part of the first reflector 14, such that the structures and/or possibly local inhomogeneities of the radiation source 12 and/or of the first side 13 of the radiation source 12 are not imaged in the far field.

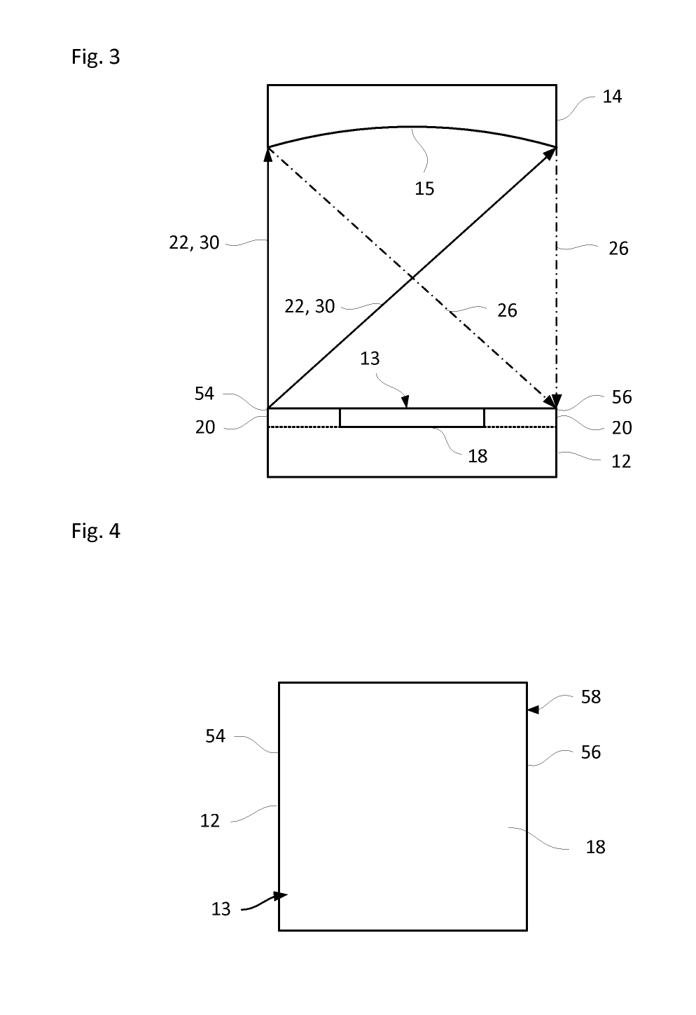

FIG. 3 shows a detailed view of an embodiment of the radiation arrangement 10, wherein essentially the radiation source 12 and the reflector 14 are illustrated. The radiation source 12 has the active and the passive region 18, 20. Alternatively, however, it is also possible for the radiation source 12 to have no passive region 20. The reflector 14 in this embodiment is configured in the form of a concave mirror. The radiation source 12 has on its upper side which is on the left-hand side in FIG. 3 a first edge section 54, and at its upper side on the right a second edge section 56. The first and/or the second edge section 54, 56 can be formed at the edge of the passive region 20 and/or at the edge of the active region 18. The reflective surface 15 of the reflector 14 is in this embodiment configured such that beam paths of the first and/or second radiation portion 30, which have their origins at the first edge section 54 and may also be referred to as edge rays, are incident on the second edge section 56 after reflection at the reflective surface 15. In other words, in various embodiments, electromagnetic radiation that is emitted and/or output at the first edge section 54 in the direction toward the reflector 14 is reflected onto the second edge section 56. Furthermore, the reflector 14 can be configured and arranged such that electromagnetic radiation that is emitted and/or output at the second edge section 54 in the direction toward the reflector 14 is reflected onto the first edge section 56, which is not illustrated in FIG. 3 for reasons of better clarity.

This can result in the entire quantity of light that is emitted and/or output by the radiation source 12 in the direction toward the first reflector 14 being reflected back onto the first side 13 of the radiation source 12. This can contribute to a particularly efficient provision of homogeneous electromagnetic radiation 32.

FIG. 4 shows a plan view of an embodiment of the radiation source 12. In this embodiment, the radiation source 12 only includes an active region 18 and no passive region 20. The radiation source 12, specifically the active region 18, has an outer edge 58 which includes the first edge section 54 and the second edge section 56. The active region 18 can be configured to be reflective and/or scattering, as is explained in more detail with respect to FIG. 1. The active region 18 can, for example, be a device emitting electromagnetic radiation or include one.

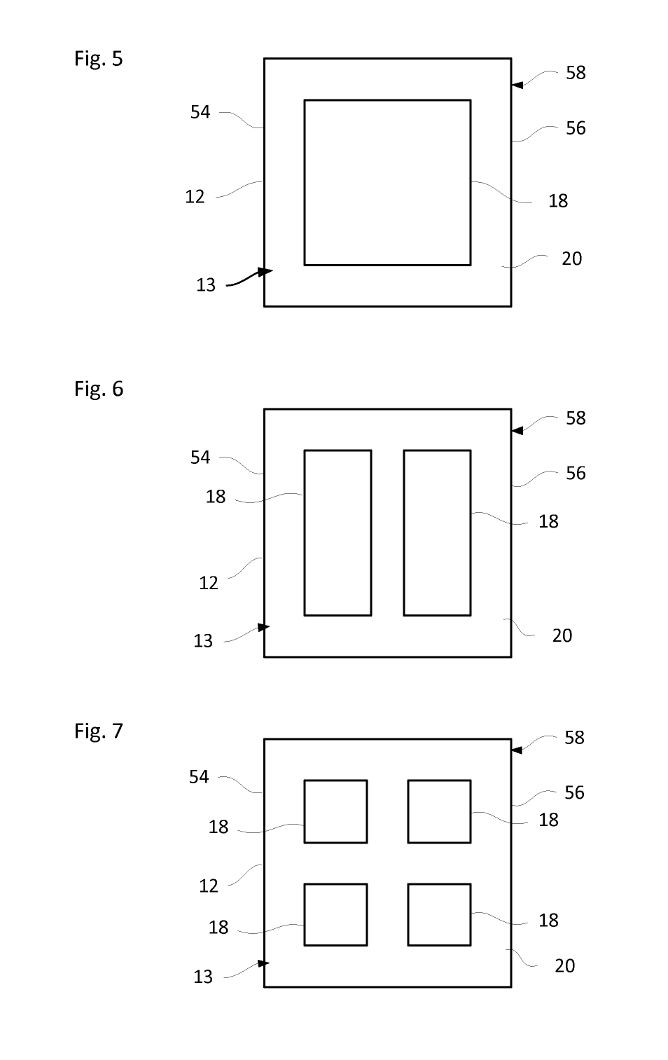

FIG. 5 shows a plan view of an embodiment of the radiation source 12. In this embodiment, the radiation source 12 includes an active region 18 and a passive region 20. The active region 18 is surrounded by the passive region 20. The radiation source 12, specifically the active and the passive regions 18, 20, has the outer edge 58, which includes the first edge section 54 and the second edge section 56. In addition to the passive region 20 which is illustrated to be situated around the active region 18, one, two or more passive regions 20 can also be formed within the active region 18. Furthermore, the active region 18 itself can be configured to be reflective and/or scattering, as is explained in more detail with reference to FIG. 1. The active region 18 can, for example, be a device emitting electromagnetic radiation or include one.

FIG. 6 shows an embodiment of the radiation source 12, which largely corresponds to the embodiment of the radiation source 12 explained with respect to FIG. 5, wherein, in contrast, in the embodiment shown in FIG. 6, the radiation source 12 has two of the active regions 18. The two active regions 18 can generate electromagnetic radiation of identical or different wavelengths. By way of example, the two active regions 18 may generate light of the same or different colors, wherein the colors of the light can be mixed using the optical body 40 and/or the reflector 14, and thus light of a further color can be generated. Furthermore, the passive region 20 can contribute to the mixing of the colors.

FIG. 7 shows an embodiment of the radiation source 12, which largely corresponds to the embodiment of the radiation source 12 explained with respect to FIG. 5, wherein, in contrast, in the embodiment shown in FIG. 7, the radiation source 12 includes four of the active regions 18. The four active regions can be four devices emitting electromagnetic radiation or four active regions 18 of a device emitting electromagnetic radiation. By way of example, the four active regions 18 can have two chips that emit green light, one chip that emits red light, and one chip that emits blue light. The space between the individual chips can in that case, for example, be filled with the highly reflective and/or white scatter material. In that case, the colors of the light can be mixed with the use of the optical body 40 and/or of the reflector 14, and thus light of a further color can be generated. The passive region 20 can furthermore contribute to the mixing of the colors.

The disclosure is not limited to the specified embodiments. By way of example, the optical body 40 can have shapes which deviate from the shapes shown in the figures. Furthermore, the radiation source 12 can include three or more than four active regions 18. By way of example, the radiation source 12 can include an LED array, for example a mid-power LED package. By way of example, the optical body 40 can be configured to be made of multiple pieces. By way of example, a corresponding lens can be arranged on the optical body 40, rather than the lens-type surface region 48.

While the disclosed embodiments have been particularly shown and described with reference to specific embodiments, it should be understood by those skilled in the art that various changes in form and detail may be made therein without departing from the spirit and scope of the disclosed embodiments as defined by the appended claims. The scope of the disclosed embodiments is thus indicated by the appended claims and all changes which come within the meaning and range of equivalency of the claims are therefore intended to be embraced.

1. A radiation arrangement for providing electromagnetic radiation, comprising:
at least one radiation source for generating and outputting electromagnetic radiation, and
an optical body, which has an outer wall and an inner wall, wherein the inner wall faces the radiation source and has a reflector, wherein the optical body is configured and arranged with respect to the radiation source such that the reflector reflects at least a portion of the electromagnetic radiation back to the radiation source, and that at least a portion of the electromagnetic radiation enters the optical body through the inner wall, and that the outer wall internally reflects at least a portion of the electromagnetic radiation which has entered the optical body, and that at least part of the internally reflected electromagnetic radiation exits the optical body.

2. The radiation arrangement as claimed in claim 1, wherein the portion of the electromagnetic radiation that is incident on the reflector includes a first radiation portion, wherein the radiation source generates and emits in the direction of the reflector, and a second radiation portion, wherein the radiation source outputs in the direction of the reflector owing to electromagnetic radiation that is incident on the radiation source after reflection at the reflector.

3. The radiation arrangement as claimed in claim 1, wherein the portion of the electromagnetic radiation that enters the optical body through the inner wall includes a third radiation portion, wherein the radiation source generates and emits in the direction of the outer wall, and a fourth radiation portion, which wherein the radiation source outputs in the direction of the outer wall owing to electromagnetic radiation that is incident on the radiation source after reflection at the reflector.

4. The radiation arrangement as claimed in claim 1, wherein the electromagnetic radiation that the radiation source outputs includes electromagnetic radiation that the radiation source reflects, scatters and/or generates owing to excitation by electromagnetic radiation that is reflected back onto the radiation source.

5. The radiation arrangement as claimed in claim 1, wherein the radiation source includes an active region, at which the radiation source generates and/or outputs the electromagnetic radiation, and a passive region, at which the radiation source reflects and/or scatters the electromagnetic radiation.

6. The radiation arrangement as claimed in claim 1, wherein the optical body has a cutout which extends into the optical body in a direction of extent and which is delimited in its direction of extent by a base area of the cutout and which is delimited vertically to its direction of extent by the inner wall of the optical body, wherein the reflector is formed on the base area.

7. The radiation arrangement as claimed in claim 5, wherein the active and/or the passive region have an outer edge and in which the reflector is configured such that it reflects the first radiation portion and the second radiation portion at least partially onto the outer edge.

8. The radiation arrangement as claimed in claim 7, wherein the outer edge has a first edge section and at least one second edge section and wherein the reflector is configured such that it reflects the first and/or second radiation portions coming from the first edge section onto the second edge section.

9. The radiation arrangement as claimed in claim 2, wherein the reflector has a reflector cutout which extends through the reflector and via which portions of the first and/or second radiation portion pass.

10. The radiation arrangement as claimed in claim 9, wherein the optical body has a lens, which is arranged in a beam path of the electromagnetic radiation passing through the reflector cutout, downstream of the reflector.

11. The radiation arrangement as claimed in claim 5, wherein the radiation source has at least one second active region for generating the electromagnetic radiation.

12. The radiation arrangement as claimed in claim 11, wherein the passive region is formed at least partially between the first active region and the second active region.

13. The radiation arrangement as claimed in claim 1, wherein the reflector is arranged on the optical body.

14. The radiation arrangement as claimed in claim 1, wherein the reflector is formed by the optical body.

15. The radiation arrangement as claimed in claim 1, wherein the optical body is a TIR optical unit.
